(19) United States
(12) Patent Application Publication
(10) Pub. No.: US 2003/0199595 A1
(43) Pub. Date: Oct. 23, 2003

(54) Device and method of creating hydrodynamic cavitation in fluids

(76) Inventor: Oleg V. Kozyuk, (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/131,512

(22) Filed: Apr. 22, 2002

(51) Int. Cl. C09K 3/00

(52) U.S. Cl. 516/20

(57) ABSTRACT

The present invention provides for a device and method of creating hydrodynamic cavitation in fluids. The device comprises a chamber formed by a wall where the wall has a first orifice and an opposing second orifice that are both in fluid communication with said chamber. The first orifice and the second orifice share the same center-line and the first orifice has a diameter smaller than that of the second orifice. The method comprises the steps of: introducing a first liquid stream through the first orifice of the device to create a first liquid jet; introducing a second liquid stream through the second orifice of the device to create a second liquid jet; creating a high shear intensity vortex contact layer when the first liquid jet interacts with and penetrates the second liquid jet; and creating and collapsing cavitation caverns and bubbles in the high shear intensity vortex contact layer.

### BACKGROUND OF THE INVENTION

1. Field of Invention

The present invention relates to a device and method for creating hydrodynamic cavitation in fluids. This device and method according to the present invention may find application in mixing, synthesis, assisting in chemical reactions, and sonochemical reactions in the chemical, food, pharmaceuticals, cosmetics processing, and other types of industry.

2. Description of the Related Art

Cavitation is the formation of bubbles and cavities within a liquid stream resulting from a localized pressure drop in the liquid flow. If the pressure at some point decreases to a magnitude under which the liquid reaches the boiling point for this fluid, then a great number of vapor-filled cavities and bubbles are formed. As the pressure of the liquid then increases, vapor condensation takes place in the cavities and bubbles, and they collapse, creating very large pressure impulses and very high temperatures. According to some estimations, the temperature within the bubbles attains a magnitude on the order of 5000° C. and a pressure of approximately 500 kg/cm². Cavitation involves the entire sequence of events beginning with bubble formation through the collapse of the bubble. Because of this high energy level, cavitation has been studied for its ability to mix materials and aid in chemical reactions.

There are several different ways to produce cavitation in a fluid. The way known to most people is the cavitation resulting from a propeller blade moving at a critical speed through water. If a sufficient pressure drop occurs at the blade surface, cavitation will result. Likewise, the movement of a fluid through a restriction such as an orifice plate can also generate cavitation if the pressure drop across the orifice is sufficient. Both of these methods are commonly referred to as hydrodynamic cavitation. Cavitation may also be generated in a fluid by the use of ultrasound. A sound wave consists of compression and decompression cycles. If the pressure during the decompression cycle is low enough, bubbles may be formed. These bubbles will grow during the decompression cycle and contract or even implode during the compression cycle.

Both of these methods of cavitation to enhance mixing or aid in chemical reactions have had mixed results, mainly due to the inability to adequately control cavitation. U.S. Pat. Nos. 5,810,052, 5,931,771 and 5,937,906 to Kozyuk disclose an improved device capable of controlling the many variables associated with cavitation.

Of relevance to the present invention are U.S. Pat. Nos. 5,466,646 and 5,417,956 to Moser which disclose the use of high shear followed by cavitation to produce metal based materials of high purity and improved nanosize. While the results disclosed in these patents are improved over the past methods of preparation, the inability to control the cavitation effects limit the results obtained.

Furthermore, U.S. Pat. No. 5,931,771 introduced a method of producing ultra-thin emulsions and dispersions, which in accordance with the invention is comprised of the passage of a hydrodynamic liquid flow containing dispersed components through a flow-through channel internally having at least one nozzle. Located after the nozzle and along the stream is a buffer channel which is directed by its open end in the nozzle side. Inside the nozzle, a high velocity primary liquid jet, which enters into the buffer channel at a minimal distance from the nozzle. In the buffer channel, flowing out from this channel, a secondary liquid jet is formed, which moves in the buffer channel towards the primary jet and forms with the surface of the primary jet a high intensity vortex contact layer. In the high intensity vortex contact layer, collapsing cavitation caverns and bubbles are generated which disperse emulsions and dispersions to submicron sizes.

In addition, the invention of U.S. Pat. No. 5,720,551 features a method for use in causing emulsification in a fluid. In the method, a jet of fluid is directed along a first path, and a structure is interposed in the first path to cause the fluid to be redirected in a controlled flow along a new path, the first path and the new path being oriented to cause shear and cavitation in the fluid. The first path and the new path may be oriented in essentially opposite directions. The coherent flow may be a cylinder surrounding the jet. The interposed structure may have a reflecting surface that is generally semi-spherical, or is generally tapered, and lies at the end of a well. Adjustments may be made to the pressure in the well, in the distance from the opening of the well to the reflecting surface, and in the size of the opening to the well. The controlled flow, as it exits the well, may be directed in an annular sheet away from the opening of the well. An annular flow of a coolant may be directed in a direction opposite to the direction of the annular sheet.

According to the invention of U.S. Pat. No. 6,227,694, a method for causing a reaction between two or more reactive substances comprises the step of colliding a flow of one reactive substance against a flow of another reactive substance at a high flow rate to cause a reaction between them. Furious turbulence and cavitation occur when the jet flows collide together at high speeds.

### SUMMARY OF THE INVENTION

The present invention provides a device for creating hydrodynamic cavitation in fluids comprising a chamber formed by a wall where the wall has a first orifice and an opposing second orifice that are both in fluid communication with said chamber. The first orifice and the second orifice share the same center-line and the first orifice has a diameter smaller than that of the second orifice. The device may further comprise a second pair of opposing orifices disposed in the wall such that the second pair of opposing orifices is in fluid communication with the chamber.

In another embodiment, a device for creating hydrodynamic cavitation in fluids comprises a flow-through channel having a wall wherein the wall has a first orifice that is in communication with the flow-through channel for introducing a first liquid stream into the flow-through channel and a second orifice opposite the first orifice that is in communication with the flow-through channel for introducing a second liquid stream into the flow-through channel. The first orifice and second orifice share the same center-line and the first orifice has a diameter smaller than that of the second orifice. The introduction of the first liquid stream through the first orifice creates a first liquid jet and the introduction of the second liquid stream through the second orifice creates a second liquid jet. When the first liquid jet impinges with the second liquid jet, the first liquid jet penetrates the second liquid jet thereby creating a high shear intensity vortex contact layer. Preferably, the flow-through channel is configured for passing a hydrodynamic liquid through the flow-through channel. The first liquid stream comprises a first liquid and the second liquid stream comprises a second liquid, where the first and second liquids may be the same or different.

In another embodiment, the present invention provides for a device for creating hydrodynamic cavitation in fluids comprising a flow-through channel for passing a hydrodynamic liquid where the flow-through channel has an outlet, a cavitation chamber situated within the flow-through channel where the cavitation chamber is defined by a wall and an exit orifice, and a restriction wall in physical communication with the wall and the flow-through channel to prevent the hydrodynamic liquid from exiting the flow-through channel before entering the first and second orifices. The wall includes a pair of opposing orifices wherein the first and second orifices share the same center-line and are in communication with the chamber and the first orifice has a diameter smaller than that of the second orifice. The device may further comprise a second cavitation chamber situated within the flow-through channel in series with the first cavitation chamber, the second cavitation chamber having a pair of opposing orifices that share the same center-line and have different diameters. Alternatively, the wall may further include a second pair of opposing orifices that share the same center-line and have different diameters.

Additionally, the present invention provides for a method of creating hydrodynamic cavitation in fluids comprising: providing a first orifice and a second opposing orifice in a wall of a chamber such that the first and second orifices share the same center-line and the first orifice has a diameter smaller than that of the second orifice; introducing a first liquid stream through the first orifice to create a first liquid jet; introducing a second liquid stream through the second orifice to create a second liquid jet; creating a high shear intensity vortex contact layer when the first liquid jet interacts with and penetrates the second liquid jet; and creating and collapsing cavitation caverns and bubbles in the high shear intensity vortex contact layer.

In another embodiment, a method of creating hydrodynamic cavitation in fluids comprising: passing a hydrodynamic liquid through a flow-through channel having a wall; providing a first orifice and a second opposing orifice in the wall of the flow-through channel such that the first and second orifices share the same center-line, the first orifice has a diameter smaller than that of the second orifice; introducing a first liquid stream through the first orifice to create a first liquid jet; introducing a second liquid stream through the second orifice to create a second liquid jet; creating a high shear intensity vortex contact layer when the first liquid jet interacts with and penetrates the second liquid jet; and creating and collapsing cavitation caverns and bubbles in the high shear intensity vortex contact layer.

Furthermore, a method of creating hydrodynamic cavitation in fluids comprising: passing a hydrodynamic liquid through a flow-through channel having an outlet; providing a cavitation chamber situated within the flow-through channel having a wall and an exit orifice; directing the liquid through the first orifice to create a first liquid jet; directing the liquid through the second orifice to create a second liquid jet; creating a high shear intensity vortex contact layer when the first liquid j et interacts with and penetrates the second liquid jet; and creating and collapsing cavitation caverns and bubbles in the high shear intensity vortex contact layer. The wall includes a pair of opposing orifices wherein the first orifice and the second orifice share the same center-line and are in communication with the chamber and the first orifice has a diameter smaller than that of the second orifice. The method may further comprise: directing the liquid exiting from the exit orifice of the chamber towards a second cavitation chamber situated downstream of the chamber in the flow-through channel; directing the liquid through the first orifice of the second cavitation chamber to create a third liquid jet; directing the liquid through the second orifice of the second cavitation chamber to create a fourth liquid jet; creating a second high shear intensity vortex contact layer when the third liquid jet interacts with and penetrates the fourth liquid jet; and creating and collapsing cavitation caverns and bubbles in the second high shear intensity vortex contact layer. The second cavitation chamber includes a wall having a pair of opposing orifices disposed therein wherein the first orifice and the second orifice share the same center-line and are in communication with the second chamber and the first orifice has a diameter smaller than that of the second orifice. Alternatively, the method may further comprise: directing the hydrodynamic liquid through a third orifice in the wall of the chamber to create a third liquid jet; directing the liquid through a fourth orifice in the wall of the chamber opposite the third orifice to create a fourth liquid jet, the third and fourth orifices share the same center-line and the third orifice has a diameter that is smaller than the fourth orifice; creating a second high shear intensity vortex contact layer when the third liquid jet interacts with and penetrates the fourth liquid jet; and creating and collapsing cavitation caverns and bubbles in the second high shear intensity vortex contact layer.

### BRIEF DESCRIPTION OF THE DRAWINGS

These and other features, aspects, and advantages of the present invention will become better understood with regard to the following description, appended claims, and accompanying drawings where:

FIG. 1 is a longitudinal cross-section of a first embodiment of the device according to the present invention wherein the device comprises a flow-through channel that includes a cavitation chamber having two opposed jetting orifices that empty into the chamber.

FIG. 2 is a longitudinal cross-section of a second embodiment of the device according to the present invention wherein two opposed jetting orifices are provided in a flow-through channel wherein the two opposed jetting orifices are the only two inlets.

FIG. 3 is a longitudinal cross-section of a third embodiment of the device according to the present invention wherein two opposed jetting orifices are provided in a flow-through channel having an inlet wherein the two opposed jetting orifices are secondary inlets.

FIG. 4 is a modification of the first embodiment of the device according to the present invention wherein the device comprises three pairs of opposing jetting orifices.

FIG. 5 is a modification of the first embodiment of the device according to the present invention wherein the device further comprises a second cavitation chamber situated in the flow-through channel in series with the first cavitation chamber.

### DESCRIPTION OF THE PREFERRED EMBODIMENTS

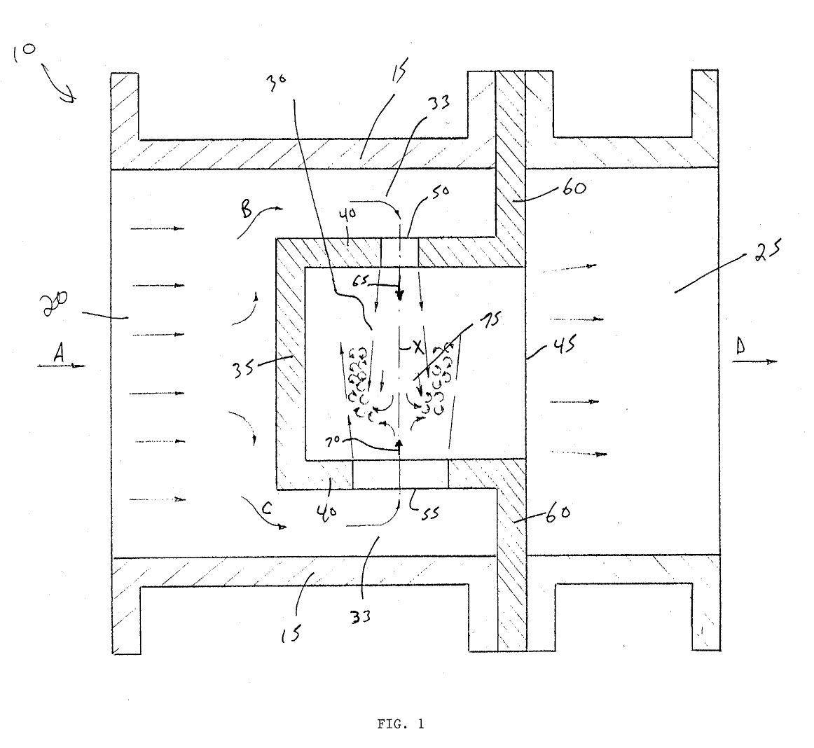

Referring now to the drawings wherein the showings are for purposes of illustrating various embodiments of the present invention only and not for purposes of limiting the same, FIG. 1 illustrates a longitudinal cross-sectional view of a first embodiment of the device 10 comprising a flow-through channel 15 having an inlet 20 and an outlet 25. Situated within the flow-through channel 15 is a cylindrical cavitation chamber 30 defined by a front wall 35 perpendicular to the flow-through channel 15, a wall 40 parallel to the flow-through channel 15, and an exit orifice 45 in communication with the outlet 25. The arrangement of the cavitation chamber 30 within the flow-through channel 15 creates an annular opening 33. Wall 40 has a first jetting orifice 50 and a second jetting orifice 55 oriented directly opposite the first jetting orifice 50 such that the first jetting orifice 50 and the second jetting orifice 55 directly face each other and share the same center-line X. The diameter of the first jetting orifice 50 is smaller than the diameter of the second jetting orifice 55. The cavitation chamber 30 also includes a flange 60 in communication with wall 40 and the flow-through channel 15 to direct fluid into the cavitation chamber 30 and restrict fluid from exiting the flow-through channel without being directed into the first jetting orifice 50 or second jetting orifice 55.

In operation, a hydrodynamic liquid stream moves along the direction, indicated by arrow A, through the inlet 20 and flows into flow-through channel 15. As the liquid stream approaches the front wall 35, the liquid stream is directed towards the annular opening 33. One portion of the liquid stream, indicated by arrow B, passes through the annular opening 33 and enters the first jetting orifice 50 forming a high velocity liquid jet 65 (hereinafter referred to as “smaller liquid jet 65” because this liquid jet exits the smaller diameter jetting orifice 50). Additionally, the other portion of the liquid stream, indicated by arrow C, passes through the annular opening 33 and enters the second jetting orifice 55 forming a high velocity liquid jet 70 (hereinafter referred to as “larger liquid jet 70” because this liquid jet exits the larger diameter jetting orifice 55).

Both smaller liquid jet 65 and larger liquid jet 70 flow into chamber 30 where they impinge along center-line X. Once the smaller liquid jet 65 and the larger liquid jet 70 impinge, smaller liquid jet 65 penetrates and interacts with larger liquid jet 70 thereby creating a high shear intensity vortex contact layer 75 between the liquid jets 65, 70. Cavitation caverns and bubbles are created in the high shear intensity vortex contact layer 75. During the collapse of cavitation caverns and bubbles, high localized pressures, up to 1000 MPa, arise and the level of energy dissipation in the flow-through channel 205 attains a magnitude in the range of 1¹⁰-1¹⁵ watt/kg. Under these physical conditions in the liquid, on the boundary of the bubble and inside the bubble itself in the gas phase, chemical reactions proceed such as oxidation, disintegration, synthesis, etc. After the cavitation bubbles collapse, the liquid is transported from the cavitation chamber 30 through the exit orifice 45 and exits the outlet 25, indicated by arrow D.

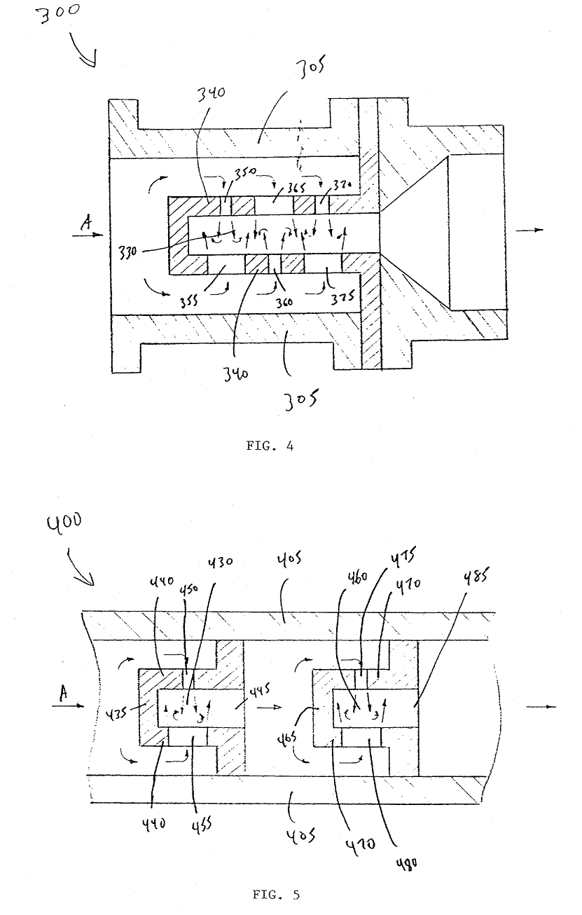

Although the first embodiment includes only one pair of opposing jetting orifices, it is possible to provide two or more pairs of opposing jetting orifices within the wall 340 and in communication with the chamber 330. As in the case of the first embodiment, the first opposing jetting orifice of each pair has a diameter smaller than that of the second opposing jetting orifice. This alternate design is shown as device 300 in FIG. 4, with arrow A representing the flow of hydrodynamic fluid through the flow-through channel 305. Wall 340 includes a first pair of opposing jetting orifices 350, 355, a second pair of opposing jetting orifices 360, 365, and a third pair of opposing jetting orifices 370, 375. The device 300 is structurally and functionally identical to the device 10 of the first embodiment, except for the addition of two pairs of opposing jetting orifices 370, 375.

Although the first embodiment includes only one cavitation chamber 30, it is possible to provide two or more cavitation chambers in series within the flow-through chamber. This alternate design is shown as device 400 in FIG. 5, with arrow A representing the flow of hydrodynamic fluid through the flow-through channel 405. The device 400 includes a first cavitation chamber 430 defined by a front wall 435, a wall 440 having a pair of opposing jetting orifices 450, 455, and an exit orifice 445. Additionally, the device 400 includes a second cavitation chamber 460 defined by a front wall 465, a wall 470 having a pair of opposing jetting orifices 475, 480, and an exit orifice 485. The device 400 is structurally and functionally identical to the device 10 of the first embodiment, except for the addition of the second chamber 460.

Furthermore, although the preferred cavitation chamber 30 is cylindrical in shape, it is contemplated that any shape may be possible provided that the liquid flow is permitted to enter the cavitation chamber 30. Such shapes may include cubical, conical, spherical, semi-spherical, or rectangular.

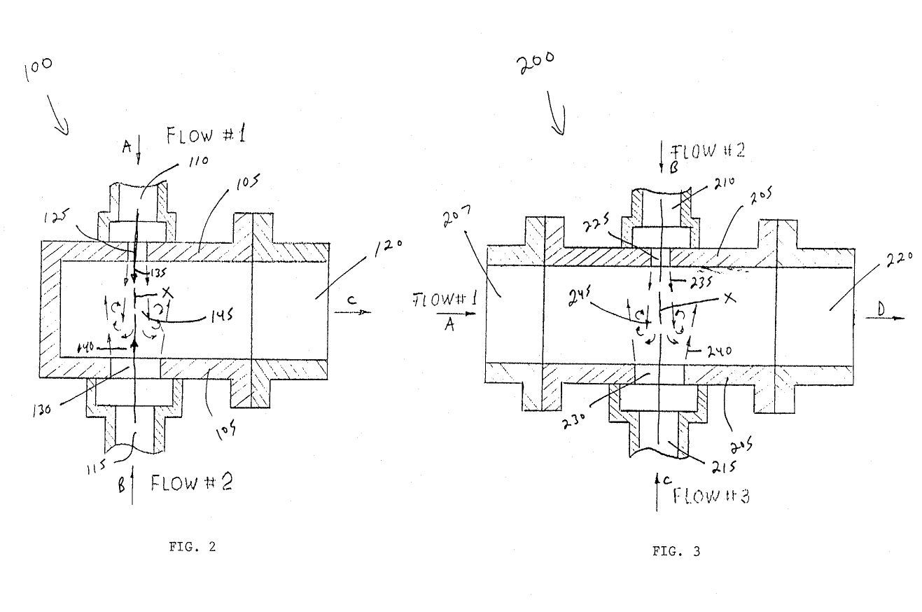

FIG. 2 represents a second embodiment according to the present invention. FIG. 2 illustrates a longitudinal cross-sectional view of the device 100 comprising a flow through channel 105 having a first inlet 110, a second inlet 115, and an outlet 120. The first inlet 110 includes a first jetting orifice 125 and the second inlet 115 includes a second jetting orifice 130. The first jetting orifice 125 is oriented directly opposite the second jetting orifice 130 such that the first jetting orifice 125 and the second jetting orifice 130 directly face each other and share the same center-line X. The diameter of the first jetting orifice 125 is smaller than the diameter of the secondjetting orifice 130.

In this embodiment, a first hydrodynamic liquid stream, indicated by arrow A, enters the first inlet 110 and passes through the first jetting orifice 125 forming a high velocity liquid jet 135 (hereinafter referred to as “smaller liquid jet 135” because this liquid jet exits the smaller diameter jetting orifice 125) that flows into flow-through channel 105. Additionally, a second hydrodynamic liquid stream, indicated by arrow B, enters the second inlet 115 and passes through the second jetting orifice 130 forming a high velocity liquid jet 140 (hereinafter referred to as “larger liquid jet 140” because this liquid jet exits the larger diameter jetting orifice 130) that flows into flow-through channel 105. Both the smaller liquid jet 135 and the larger liquid jet 140 flow into the flow-through channel 105 where they impinge along center-line X. Once the smaller liquid jet 135 and the larger liquid jet 140 impinge, smaller liquid jet 135 penetrates and interacts with larger liquid jet 140 thereby creating a high shear intensity vortex contact layer 145 between the liquid jets 135, 140. Cavitation caverns and bubbles are created in the high shear intensity vortex contact layer 145. During the collapse of cavitation caverns and bubbles, high localized pressures, up to 1000 MPa, arise and the level of energy dissipation in the flow-through channel 205 attains a magnitude in the range of 1¹⁰-1¹⁵ watt/kg. Under these physical conditions in the liquid, on the boundary of the bubble and inside the bubble itself in the gas phase, chemical reactions proceed such as oxidation, disintegration, synthesis, etc. After the cavitation bubbles collapse, the liquid is transported from the flow-through channel 105 to the outlet 120 indicated by arrow C.

The device 100 according to the present invention is capable of receiving liquids having the same or different characteristics, which provides the operator with the ability to modify and control the desired cavitation effects. It is important to note that the first and second hydrodynamic liquid streams discussed above comprise a first and second liquid, respectively. The first and second liquids may be the same liquid, different liquids, or any combination thereof. Each liquid may be a pure liquid, a liquid containing solid particles, a liquid containing droplets, an emulsion of multiple materials, a slurry, or a suspension. Additionally, each liquid may be introduced to the device under different physical conditions and chemical compositions. Such physical conditions may include pressure, temperature, viscosity, and density. Such chemical compositions may include different chemical formulations and concentrations.

Furthermore, although the second embodiment illustrates a flow-through channel having a pair of opposing jetting orifices disposed therein, it is contemplated that any chamber may be provided with a pair of opposing jetting orifices to practice the present invention. Such chambers may include tank, a pipe, a spherical vessel, a cylindrical vessel such as a drum, or any other desired shape. It is also contemplated that any size and shape may be possible provided that the liquid flow is permitted to enter the chamber. Such shapes may include cubical, conical, spherical, semi-spherical, or rectangular.

FIG. 3 represents a third embodiment according to the present invention. FIG. 3 illustrates a longitudinal cross-sectional view of the device 200 comprising a flow through chamber 205 having an inlet 207 and an outlet 220. The flow-through channel also includes a first ancillary inlet 210 and a second ancillary inlet 215. The first ancillary inlet 210 includes a first jetting orifice 225 and the second ancillary inlet 215 includes a second jetting orifice 230. The first jetting orifice 225 is oriented directly opposite the second jetting orifice 230 such that the first jetting orifice 225 and the second jetting orifice 230 directly face each other and share the same center-line X. The diameter of the first jetting orifice 225 is smaller than the diameter of the second jetting orifice 230.

In this embodiment, a first hydrodynamic liquid stream moves along the direction, indicated by arrow A, through the inlet 207 and flows into the flow-through channel 205. As the liquid stream is passing through the flow-through channel 205, a second hydrodynamic liquid stream, indicated by arrow B, enters the first ancillary inlet 210 and passes through the first jetting orifice 225 forming a high velocity liquid jet 235 (hereinafter referred to as “smaller liquid jet 235” because this liquid jet exits the smaller diameter jetting orifice 225) that flows into flow-through channel 205. Additionally, a third hydrodynamic liquid stream, indicated by arrow C, enters the second ancillary inlet 215 and passes through the second jetting orifice 230 forming a high velocity liquid jet 240 (hereinafter referred to as “larger liquid jet 240” because this liquid jet exits the larger diameter jetting orifice 230) that flows into flow-through channel 205. Both the smaller liquid jet 235 and the larger liquid jet 240 flow into the flow-through chamber 205 where they impinge along center-line X. Once the smaller liquid jet 235 and the larger liquid jet 240 impinge, smaller liquid jet 235 penetrates and interacts with larger liquid jet 240 thereby creating a high shear intensity vortex contact layer 145 between the liquid jets 235, 240 and the first liquid flow. Cavitation caverns and bubbles are created in the high shear intensity vortex contact layer 245. During the collapse of cavitation caverns and bubbles, high localized pressures, up to 1000 MPa, arise and the level of energy dissipation in the flow-through channel 205 attains a magnitude in the range of 1¹⁰-1¹⁵ watt/kg. Under these physical conditions in the liquid, on the boundary of the bubble and inside the bubble itself in the gas phase, chemical reactions proceed such as oxidation, disintegration, synthesis, etc. After the cavitation bubbles collapse, the liquid stream is transported from the flow-through channel to the outlet 220, indicated by arrow D.

The device 200 according to the present invention is capable of receiving liquids having the same or different characteristics, which provides the operator with the ability to modify and control the desired cavitation effects. It is important to note that the first and second hydrodynamic liquid streams discussed above comprise a first and second liquid, respectively. The first and second liquids may be the same liquid, different liquids, or any combination thereof. Each liquid may be a pure liquid, a liquid containing solid particles, a liquid containing droplets, an emulsion of multiple materials, a slurry, or a suspension. Additionally, each liquid may be introduced to the device under different physical conditions and chemical compositions. Such physical conditions may include pressure, temperature, viscosity, and density. Such chemical compositions may include different chemical formulations and concentrations.

Furthermore, although the third embodiment illustrates a flow-through channel having a pair of opposing jetting orifices disposed therein, it is contemplated that any chamber may be provided with a pair of opposing jetting orifices to practice the present invention. Such chambers may include tank, a pipe, a spherical vessel, a cylindrical vessel such as a drum, or any other desired shape. It is also contemplated that any size and shape may be possible provided that the liquid flow is permitted to enter the chamber. Such shapes may include cubical, conical, spherical, semi-spherical, or rectangular.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

Having thus described the invention, it is now claimed:

1. A device for creating hydrodynamic cavitation in fluids comprising:
a chamber formed by a wall,
said wall having a first orifice and an opposing second orifice that are both in fluid communication with said chamber, wherein said first orifice and second orifice share the same center-line and said first orifice has a diameter smaller than that of said second orifice.

2. The device of claim 1, further comprising a second pair of opposing orifices disposed in said wall such that said second pair of opposing orifices is in fluid communication with said chamber.

3. The device of claim 2, wherein said second pair of opposing orifices share the same center-line.

4. The device of claim 2, wherein said second pair of opposing orifices have different sized diameters.

5. A device for creating hydrodynamic cavitation in fluids comprising:
a housing having a wall defining an interior,
said housing having a first orifice and an opposing second orifice that are both in fluid communication with said interior, wherein said first orifice and second orifice share the same center-line and said first orifice has a diameter smaller than that of said second orifice.

6. A device for creating hydrodynamic cavitation in fluids comprising:
a flow-through channel having a wall,
said wall having a first orifice that is in communication with said flow-through channel for introducing a first liquid stream into said flow-through channel,
said wall having a second orifice opposite said first orifice that is in communication with said flow-through channel for introducing a second liquid stream into said flow-through channel,
wherein said first orifice and second orifice share the same center-line and said first orifice has a diameter smaller than that of said second orifice.

7. The device of claim 6, wherein the introduction of the first liquid stream through the first orifice creates a first liquid jet and the introduction of the second liquid stream through the second orifice creates a second liquid jet.

8. The device of claim 7, wherein the first liquid jet impinges with the second liquid jet such that said first liquid jet penetrates said second liquid jet thereby creating a high intensity shear layer.

9. The device of claim 6, wherein the flow-through channel is configured for passing a hydrodynamic liquid through said flow-through channel.

10. The device of claim 6, wherein the first liquid stream comprises a first liquid and the second liquid stream comprises a second liquid.

11. The device of claim 10, wherein the first and second liquids are different.

12. The device of claim 10, wherein the first and second liquids are the same.

13. A device for creating hydrodynamic cavitation in fluids comprising:
a flow-through channel for passing a hydrodynamic liquid, said flow-through channel having an outlet;
a cavitation chamber situated within said flow-through channel, said cavitation chamber defined by a wall and an exit orifice wherein:
said wall includes a pair of opposing orifices wherein the first and second orifices share the same center-line and are in communication with the chamber and said first orifice has a diameter smaller than that of said second orifice, and
said exit orifice is in communication with said outlet;
a restriction wall in physical communication with said wall and said flow-through channel to prevent the hydrodynamic liquid from exiting the flow-through channel before entering said first and second orifices.

14. The device of claim 13, further comprising a second cavitation chamber situated within said flow-through channel in series with the first cavitation chamber, said second cavitation chamber having a pair of opposing orifices that share the same center-line and have different diameters.

15. The device of claim 13, wherein the wall includes a second pair of opposing orifices that share the same center-line and have different diameters.

16. A method of creating hydrodynamic cavitation in fluids comprising:
providing a first orifice and a second opposing orifice in a wall of a chamber such that the first and second orifices share the same center-line and the first orifice has a diameter smaller than that of said second orifice;
introducing a first liquid stream through said first orifice to create a first liquid jet;
introducing a second liquid stream through said second orifice to create a second liquid jet;
creating a high shear intensity vortex contact layer when said first liquid jet interacts with and penetrates said second liquid jet; and
creating and collapsing cavitation caverns and bubbles in said high shear intensity vortex contact layer.

17. A method of creating hydrodynamic cavitation in fluids comprising:
passing a hydrodynamic liquid through a flow-through channel having a wall;
providing a first orifice and a second opposing orifice in said wall of said flow-through channel such that the first and second orifices share the same center-line, said first orifice has a diameter smaller than that of said second orifice;
introducing a first liquid stream through said first orifice to create a first liquid jet;
introducing a second liquid stream through said second orifice to create a second liquid jet;
creating a high shear intensity vortex contact layer when said first liquid jet interacts with and penetrates said second liquid jet; and
creating and collapsing cavitation caverns and bubbles in said high shear intensity vortex contact layer.

18. A method of creating hydrodynamic cavitation in fluids comprising:
passing a hydrodynamic liquid through a flow-through channel having an outlet;
providing a cavitation chamber situated within said flow-through channel having a wall and an exit orifice wherein:
said wall includes a pair of opposing orifices wherein the first orifice and the second orifice share the same center-line and are in communication with said chamber and said first orifice has a diameter smaller than that of said second orifice, and
said exit orifice is in communication with said outlet;
directing said liquid through said first orifice to create a first liquid jet;
directing said liquid through said second orifice to create a second liquid jet;
creating a high shear intensity vortex contact layer when said first liquid jet interacts with and penetrates said second liquid jet; and
creating and collapsing cavitation caverns and bubbles in said high shear intensity vortex contact layer.

19. The method of claim 18, further comprising:
directing the liquid exiting from the exit orifice of said chamber towards a second cavitation chamber situated downstream of said chamber in said flow-through channel;
said second cavitation chamber includes a wall having a pair of opposing orifices disposed therein wherein the first orifice and the second orifice share the same center-line and are in communication with said second chamber and said first orifice has a diameter smaller than that of said second orifice, and
directing said liquid through said first orifice of said second cavitation chamber to create a third liquid jet;
directing said liquid through said second orifice of said second cavitation chamber to create a fourth liquid jet;
creating a second high shear intensity vortex contact layer when said third liquid jet interacts with and penetrates said fourth liquid jet; and
creating and collapsing cavitation caverns and bubbles in said second high shear intensity vortex contact layer.

20. The method of claim 18, further comprising:
directing said hydrodynamic liquid through a third orifice in said wall of said chamber to create a third liquid jet; said
directing said liquid through a fourth orifice in said wall of said chamber opposite said third orifice to create a fourth liquid jet, said third and fourth orifices share the same center-line and said third orifice has a diameter that is smaller than said fourth orifice;
creating a second high shear intensity vortex contact layer when said third liquid jet interacts with and penetrates said fourth liquid jet; and
creating and collapsing cavitation caverns and bubbles in said second high shear intensity vortex contact layer.
